(19) United States
(12) Patent Application Publication
(10) Pub. No.: US 2020/0210980 A1
(43) Pub. Date: Jul. 2, 2020

(54) SYSTEMS AND METHODS TO METER WHOLESALE ENERGY TRANSACTIONS USING RETAIL METER DATA

(71) Applicant: GridX, Inc., Milpitas, CA (US)

(72) Inventors: Jian Zhang, Sunnyvale, CA (US); Wei Qin, Nanjing (CN)

(21) Appl. No.: 16/666,993

(22) Filed: Oct. 29, 2019

Related U.S. Application Data
(60) Provisional application No. 62/785,173, filed on Dec. 26, 2018.

(51) Int. Cl. G06Q 20/14; G01D 4/00; G01D 4/16; G06Q 50/06

(52) U.S. Cl. CPC G06Q 20/145; G06Q 50/06; G01D 4/16; G01D 4/002

(57) ABSTRACT

The present disclosure describes systems and methods for providing virtual wholesale metering in a population of utility resource consumers using interval data collected from retail utility meters. The systems and methods may be used for generating settlement quality metering data (SQMD), deriving the approximate interval data for a sub-population of customers, or improving the accuracy of interval data.

### CROSS-REFERENCE TO RELATED APPLICATIONS

This application claims the benefit of U.S. Provisional Patent Application Ser. No. 62/785,173, filed Dec. 26, 2018, which is incorporated by reference herein in

### TECHNICAL FIELD

Various embodiments concern systems and methods to meter the amount of wholesale energy transacted by aggregating meter reads from retail electric meters. Specifically, the systems and methods involve operating Virtual utility Virtual Wholesale Metering System (VWMS), without deploying physical wholesale meters, to calculate Settlement Quality Meter Data (SQMD) for a class of virtual electric utilities.

### BACKGROUND

Metering of wholesale energy transactions is important because it determines the amount of energy transacted between energy suppliers and wholesale markets and Load Serving Entities, commonly known as distribution utilities. The wholesale metering forms the basis for determining their financial obligations to one another and to be settled between the utilities and their suppliers. Traditionally, in energy markets, such wholesale metering methods involve deployment of wholesales energy meters across utilities service territories to meter the amount of energy delivered to the utilities by suppliers at various injection locations. These utilities, due to the nature of their ownerships of and responsibilities to operate physical grids and metering systems, are known as “Physical Distribution Utilities (PDU's).”

As a part of deregulation of electricity distribution industry worldwide, a new class of distribution utilities have emerged and entered the markets. These new entrants, legitimatized by certain legislatures and regulations, buy energy from wholesale suppliers and/or wholesale energy markets, and sell energy to residential and commercial customers using the distribution grids and retail metering systems owned and operated by the traditional PDU's. Since they do not operate the physical distribution grids and metering systems, these new entrants are known as “Virtual Distribution Utilities (VDU's)” and are referred to in practices as either Retail Energy Suppliers (RES), Direct Access Providers (DAP), or Community Choice Aggregators (CCA). While relying on the PDU's to meter the energy delivered to their retail customers, these VDU's do not have access to the wholesale electric metering systems owned and operated by PDU's to determine amount of energy transacted between them and the wholesale suppliers and markets and qualify the amount of electricity delivered to them by their energy suppliers.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 is a diagram depicting a context for operating the VWMS to determine SQMD according to various embodiments disclosed herein.

FIG. 2 is a flowchart illustrating the various steps performed by the VWMS to determine SQMD according to various embodiments disclosed herein.

FIG. 3a is a flowchart illustrating the various steps performed to determine SQMD from a MV90 meter according to various embodiments disclosed herein.

FIG. 3b is a flowchart illustrating the various steps performed to determine SQMD from a smart meter according to various embodiments disclosed herein.

FIG. 3c is a flowchart illustrating the various steps performed to determine SQMD from an analog meter according to various embodiments disclosed herein.

FIG. 4 is a communication network diagram of a data network that facilitates the collection of data from the retail meters and exchange of metered data from a PDU to a VDU so that the said system can be used to calculate SQMD according to various embodiments disclosed herein.

FIG. 5 is a block diagram illustrating an example of a processing system according to various embodiments disclosed herein.

FIG. 6 is a diagram of a distribution loss factors (DLF) file format.

FIG. 7 is a chart depicting the energy consumption of various groups of utility resource consumers.

FIG. 8 is a block diagram illustrating a system for providing virtual wholesale metering in a population of utility resource consumers.

The drawings depict various embodiments for illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

In the energy market, an energy producer or supplier may provide energy to a Load Serving Entity (LSE), including traditional physical distribution utilities, RES and CCA. The LSE in turn sells energy to residential, commercial, and other customers. The transaction of selling energy by an energy producer to an LSE may be facilitated by a wholesale energy market such as an Independent System Operator (ISO). For example, CAISO is an ISO that oversees the operation California's electricity market including the transmission lines and the electricity generated by members of CAISO and the settlement between buyers and sellers of energy on a wholesale basis. Although described in the context of energy markets, the various embodiments described herein can be applied to any utility resource market such as water, gas, and other resource.

The transaction of buying and selling energy on the energy market (e.g., transactions on an ISO) requires the accurate measurement of the amount of energy supplied and bought. Generally, SQMD is the basis for accurate settlement and billing that accurately reflect the amount of energy procurement by an LSE during a settlement period. For example, SQMD is used to accurately represent the amount of energy purchased by an LSE from an energy supplier or producer.

Utility metering systems may be used to measure the amount of utility resources bought (e.g., energy from the wholesale suppliers) and sold (e.g., energy sold to retail customers) by an LSE. The resources bought by an LSE may be measured using wholesale meters, while the resources sold by an LSE may be measured using retail meters.

### Physical Wholesale Meters

Two possible sources of SQMD include CAISO Metered Entities (meter data directly collected by CAISO) and Scheduling Coordinator Metered Entities (meter data submitted to CAISO by Scheduling Coordinators), both of which require deployment of physical wholesale meters to meter the wholesale energy delivered to certain locations. The wholesale meters are installed in certain selected locations such as at a power substation. Each of these locations may be considered a local node in an electric transmission grid. The local node may function as a point where utility resources are injected. In some embodiments, each local node may have a local marginal price. Therefore, electricity injected at a node is priced at the local marginal price associated with that node.

### Physical Retail Meters

Utilities worldwide have deployed retail meters to meter the amount of energy delivered to their customers individually. These meters are calibrated and certified to be “revenue grade” and are read in periodic intervals (e.g., hourly, every 15 minutes, etc.). The interval meter read data is used by the utilities to settle with and bill their customers for the energy delivered. Retail meters may include MV90 meters, smart meters, and analog meters. Smart meters are connected to Advanced Metering Infrastructure (AMI) networks to transmit measured meter readings.

Given that the retail meters are certified to be as accurate as the wholesale electric meters, the retail meter data can be used, after proper aggregation across certain customer population, calibration against register read data, and correction with distribution grid loss, to calculate the financial equivalent of the wholesale electric meter data. The systems and methods to perform such calculation, calibration and error correction are described in this disclosure.

### Virtual Wholesale Metering

As described above, physical wholesale meters may be used to measure the amount of electricity bought/sold by an individual LSE/energy supplier or producer.

The emergence of virtual distribution utilities such as RES and CCA entities in the energy marketplace has resulted in market participants that do not have access to physical wholesale meters. These virtual distribution utilities typically rely on distribution utilities' physical infrastructure to transmit electricity to customers. Since distribution utilities operate retail meters as described above, virtual distribution utilities may utilize retail meter systems from distribution utilities to virtually meter the energy they buy by aggregating the retail meter data to generate accurate virtual wholesale metering data. As described in further detail below, generating accurate virtual whole metering data is generally accomplished by performing one or more of the following steps: acquiring retail meter data from physical distribution utility, pre-processing the meter data, accounting for distribution loss, calculating SQMD by aggregating across all meters, and repeating and revising the SQMD based on settlement cycles.

Virtual wholesale metering allows virtual distribution utilities, such as RES and CCA entities, to determine how much energy is bought from energy suppliers and producers without the use of physical wholesale meters. For example, even if a virtual distribution utility such as a CCA entity may not have access to physical wholesale meters to measure how much energy is procured from an energy supplier or producer, it may have access to retail meters operated by distribution utilities. Using the system and method described herein, the CCA may implement a virtual wholesale metering that generates accurate SQMD data.

The system and methods described herein also facilitates fine-grained virtual wholesale metering. This allows market participants to define utility consumer groups in a generalized way without being limited to where the physical nodes and meters are located. For example, a market participant may be interested in defining a utility consumer group that corresponds to a specific city, street, neighborhood, consumer type, billing plan, etc., even if there are no physical nodes or meters corresponding to the utility consumer group.

In one embodiment, utility consumer groups may be defined to include consumers within a distribution utility or an LSE. In other embodiments, utility consumer groups allow market participants to determine the amount of energy consumed by specific sets of consumers within varied levels of locality. In fact, the utility consumer group may not be limited to certain locality at all. In another example, a market participant, interested in metering the aggregated consumption by a set of customers spread across geographically wide span of non-contiguous localities, may also use the system and methods described herein to define virtual wholesale nodes even if they are not locally contained.

Fine-grained virtual metering may be used by virtual distribution utilities as well as distribution utilities or other market participants. Market participants may use fine-grained virtual metering to design and provide sophisticated products, services, and customer support. Market participants may measure and analyze the energy consumption patterns of different sets of customers to generate billing quality analytics. The billing quality analytics may be used to design products and services (e.g., rate designs based upon usage, time, schedules, etc.). For example, virtual distribution utilities, and/or distribution utilities may develop a pricing plan that is attractive to neighborhoods that have industrial energy consumers and develop another pricing plan that is attractive to neighborhoods that have residential consumers. In another example, market participants may use fine-grained virtual metering to perform financial analysis and reporting. Virtual distribution utilities, and/or distribution utilities may use data from virtual fine-grained virtual metering to collect data such as revenue, expenses, and profitability associated with specific markets or consumers.

Fine-grained virtual metering may also be used to analyze consumer consumption behavior. In some embodiments, the analysis may produce insight to help virtual and physical distribution utilities enhance customer marketing and outreach. For example, virtual and physical distribution utilities may provide information to customers to analyze usage patterns and help determine what products and services that is most desirable to individual customers. In one example, customers may use the information to determine when to charge their electric vehicles and what type of solar panels to install.

### Technology Overview

Described herein are systems and methods for accurately calculating SQMD for virtual wholesale metering by using the retail utility meters to record the wholesale energy bought and sold and consumption of utility resources (“metered data”) such as water, electricity, and gas. Additionally, one or more computer systems may collect the metered data for processing. Finally, a communication system may facilitate the communication of metered data between the utility meters and computer systems.

As described above, retail meters may be installed at residential, business, or industrial customers' sites. The data generated by retail utility meters provide a basis for accurate settlement calculations with the distribution utilities' suppliers and customers during a settlement period. To ensure accurate calculations, retail metering requires various calibration, certification, and auditing processes. To maintain the proper operation of a distribution grid, the amount of energy bought and sold must be the same, after accounting for certain distribution grid losses.

### Virtual Distribution Utilities

In some utility environments, virtual distribution utilities have access only to the retail meter data but not wholesale meter data. Examples of virtual distribution utilities include RES, DAP's, and CCA's. Therefore, the metering of the energy bought from their energy supplier may be derived from the amount of energy sold to their retail customers by aggregating the retail meter data. The various embodiments introduced herein are systems and methods for using utility retail meters to perform the wholesale SQMD calculations. The utility meters may be revenue grade retail meters that generate data collected by distribution utility companies such as PG&E.

### Retail Metering

For retail billing purpose, distribution utility companies collect data from various types of meters such as smart meters, MV90 meters and analog meters.

As of 2018, smart meters comprise approximately 60% of the electricity meters in the US. In distribution utilities that have deployed the AMI networks, the smart meters may comprise more than 95% of the overall meters. Typically, utility companies collect two sets of consumption data from each smart meter: (1) interval data on a daily basis and (2) register data at the end of the billing cycles. The interval data is used to measure the energy consumption on an hourly basis by residential customers and every 15 minutes by the commercial and agricultural customers. For example, interval data that is used to meter the energy consumption on an hourly basis results in 24 readings per day. If a billing cycle includes 30 days, then there will be 720 interval readings per billing cycle. The interval data is subject to rules and regulations such as the California Public Utilities Commission (CPUC) standardized Validating, Editing, and Estimating (VEE) process to correct the missing reads and other defects resulted from the metering systems prior to being used for billing purpose.

Smart meters are generally electronic devices that measure the usage of utility resources automatically over always on data networks. For example, a smart meter may measure the use of electricity, gas, or water. The smart meters may transmit the metered consumption data to utilities companies for monitoring, billing, and recording purposes. The communication of metered data between smart meters and utilities companies may be facilitated by an AMI that provides two-way communications. Additionally, the transmission of metered data may be performed using both wired and/or wireless networks.

MV90 legacy meters are typically certified to provide revenue grade measurements and are often used for metering commercial customers' energy consumption. The data generated by the MV90 legacy meters are typically read on a 15-minute basis. Analog meters may collect register data and are typically for residential customers who do not use smart meters.

### Computing Device

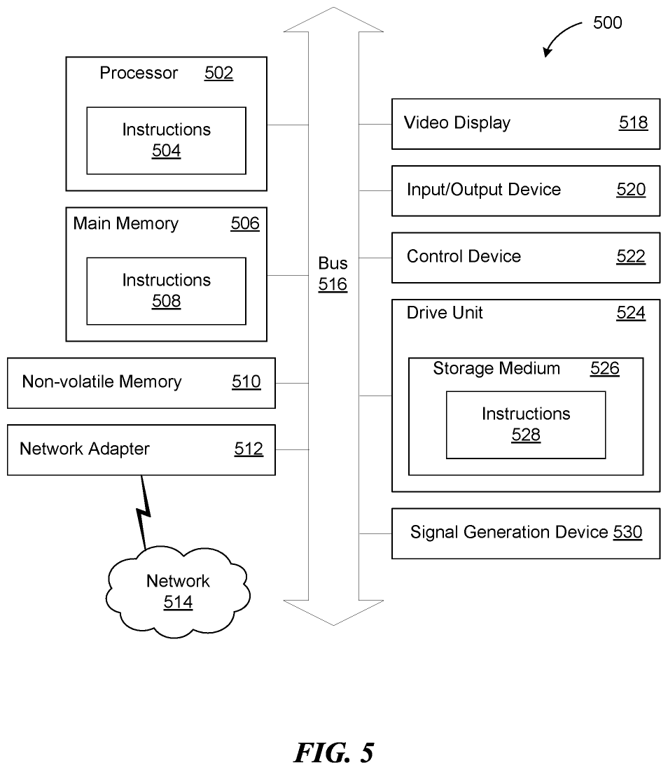

A computing device may be part of the system for determining SQMD. In some embodiments, the computing device may be in communication with utility meters to receive metered data. The computing device may store the metered data locally or transmit the metered data to a remote data storage. In addition, the computing device may include processors for calculating SQMD using the received metered data. In some embodiments, the computing device may be implemented using the processing system 500 described in FIG. 5. Additionally, computing device may be implemented as a distributed computing system where communications, processing, and storage may be distributed over multiple devices.

### Settlement Quality Meter Data System

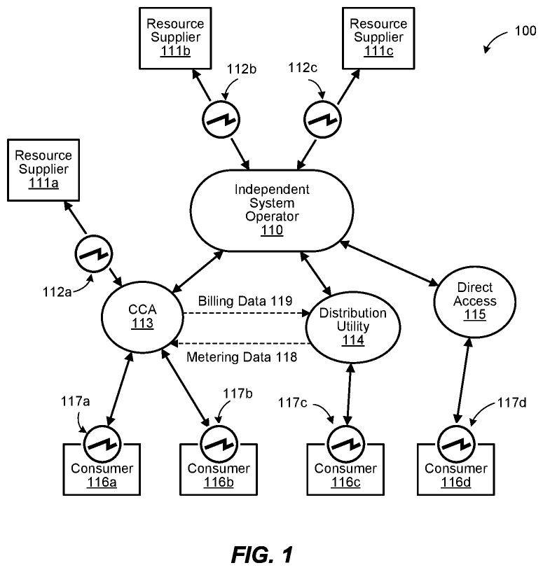

FIG. 1 illustrates a system 100 for operating utility meters to determine settlement quality meter data. The system includes an Independent System Operator (ISO) 110 that functions as a marketplace for various participants in a utility resource market. Specifically, ISO 110 allows for utility suppliers to sell utility resources to buyers. In some embodiments, the suppliers may include resource suppliers 111a-111c and the buyers may include community choice aggregation (CCA) entity 113, distribution utility 114, and Direct Access (DA) service 115.

Resource supplier 111a may produce and/or provide utility resources directly to buyers (e.g., CCA 113) without going through a marketplace. Alternatively, or additionally, resource suppliers 111b-111c may produce and/or provide utility resources to physical distribution utilities 114 participating in the ISO 110. Other virtual distribution utilities (e.g., CCA 113, DA 115 or RES) may also participate in ISO 110. Both distribution utility 114 and virtual distribution utilities in turn sell the purchased utility resource to consumers 116a-116d. In some embodiments, resource suppliers may provide specialized resources such as electricity produced from solar power, wind power, etc.

ISO 110 typically operates their own wholesale meters 112b-112c, respectively, to measure the amount of utility resource (e.g., electricity) is bought/sold by resource buyers/suppliers. In some embodiments, meters 112a-112c are wholesale meters that measure the wholesale energy delivered to electric transmission grid nodes such as local nodes and substations. For example, meter 112a measures how much electricity is provided by resource supplier 111a to a node associated with a CCA 113. Similarly, meter 112b measures the amount of utility resource that is provided by resource supplier 112b to a node associated with ISO 110. Overall, the functionality of meters 112a-112c may be considered as measuring the amount of utility resource input to a node for sell to buyers (e.g., CCA 113, distribution utility 114, and DA 115).

Distribution utility 114 is a distribution utility company that provides the physical infrastructure for delivering utility resources to consumers. The infrastructure includes power lines, transformers, substations, and other facilities for delivering the resource utility. Additionally, distribution utility companies may also produce or obtain utility resources for selling to retail consumers. Distribution utility 114 may sometimes include generation assets for producing utility resources such as power plants that generate electricity. More commonly, distribution utility 114 provides transmission and distribution (T&D) services through their physical infrastructure.

CCA 113, DA 115, and RES are virtual distribution utilities that do not possess the physical infrastructure for delivering utility resources. Rather, the virtual distribution utilities are the business entities that form business relationships with resource suppliers to obtain utility resources and business relationships with consumers (e.g., consumers 116a-116d) to sell utility resources.

The arrows depicted in FIG. 1 may represent the direction of utility resources in the business relationships between different entities. For example, the arrow between CCA 113 to consumer 116a may represent a business relationship where CCA 113 is the seller and consumer 116a is the buyer of electricity. The actual delivery of electricity from CCA 113 to consumer 116a typically relies on the physical infrastructure of a distribution utility company such as distribution utility 114, which may be independent from the relationships depicted in FIG. 1. However, in some embodiments the arrows depicted in FIG. 1 may represent both the business relationship as well as the physical interconnection for the transmission of electricity.

For example, the arrow between Distribution Utility 114 and consumer 116c may represent both a business relationship and a physical interconnection. Additionally, the arrow between Distribution Utility 114 and consumer 116c is depicted as a bi-directional arrow representing the potential bi-directional flow of utility resources. Consumer 116c may be a consumer as well as a generator of utility resources. Consumer 116c may generate energy that is provided to a utility for consumption by other consumers. For example, solar panels may generate excess energy at a consumer site that flows to the utility for consumption by other consumers.

Consumers 116a-116d engage with utilities such as CCA 113, distribution utility 114, and DA 115 to buy utility resources. For example, consumer 116a and 116b may purchase electricity from CCA 113. CCA 113 utilizes the physical infrastructure of distribution utility 114 to deliver electricity to consumers 116a and 116b. Similarly, consumer 116c obtains utility resources from distribution utility 114 and consumer 116d obtains utility resources from DA 115.

Distribution Utility typically installs retail meters 117a-117d in consumers 116a-116d premises, respectively that are used to measure the amount of utility resource consumed. In some embodiments, meters 117a-117d are retail meters that measure the amount of electricity received by consumers 116a-116d, respectively. For example, meter 117a measures the amount of electricity received by consumer 116a from CCA 113, meter 117b measures the amount of electricity received by consumer 116b from CCA 113, meter 117c measures the amount of electricity received by consumer 116c from distribution utility 114, and meter 117d measures the amount of electricity received by consumer 116d from DA 115.

Besides transmission and distribution of utility resources, system 100 also facilitates accurate billing to consumers for the utility resources that are consumed. For example, distribution utility 114 may generate bills to every consumer connected on its physical infrastructure. As described above, consumers that purchase utility resources from suppliers other than distribution utility 114 (e.g., virtual distribution utilities such as CCA 113 and DA 115) may still rely on the physical infrastructure of distribution utility 114 to receive the utility resource. Distribution utility 114 generates bills that are sent to consumers on its physical infrastructure (e.g., consumers 116a-116d). The bills may contain two components: a first component that covers the cost of the electricity provided by a virtual distribution utility (e.g., CCA 113 or DA 115), and a second component that covers the charges of the transmission and distribution of the utility resource distribution utility 114.

In some embodiments, CCA 113 may receive metered data 118 from distribution utility 114. Metered data 118 may be the measurement by retail meters such as utility meters 117a-117d. Metered data 118 may be used by CCA 113 to calculate billing charges 119. In turn, billing charges 119 may be used by distribution utility 114 to generate the first component of the bill sent to consumers as described above.

Procedures of Calibrating Interval Data with Register Billing Data

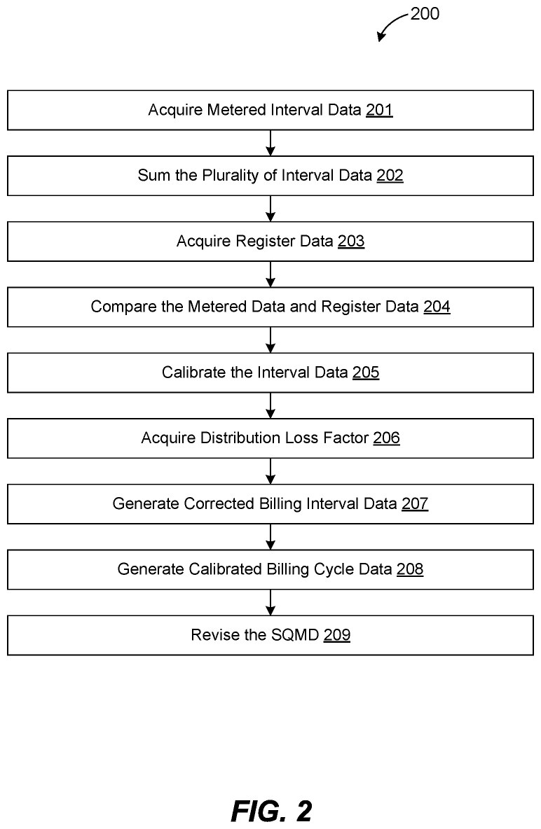

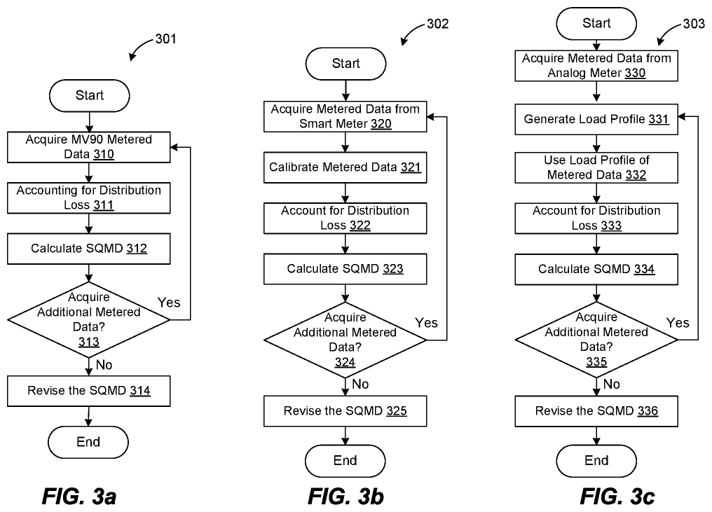

FIG. 2 illustrates a process 200 for calibrating interval data using register billing data. The process of FIG. 2 can be executed in conjunction the various methods described herein. For example, the steps in process 200 may be applied to different types of meters such as in the processes described in FIGS. 3a-3c.

At step 201, a computer system acquires a plurality of interval data indicating utility resource consumption measured by a utility meter from a distribution utility. In some embodiments, the utility meter is a smart meter that reads interval data every preset interval and register data per billing cycle. In other embodiments, the utility meter is a MV90 meter that reads interval data or an analog meter that reads register data. In certain embodiments, smart meters may provide the interval data by transmitting the data over an Advanced Metering Infrastructure (AMI) network.

Additionally, the interval data may account for energy generated by a net energy metering (NEM) consumer. For example, a facility that receives utility resources for consumption may also have resource generation capabilities such as using solar panels for generating electricity.

At step 202, the computer system sums plurality of interval data within a billing cycle. The interval data may be measured by a utility meter every pre-determined time period. For example, interval data may be measured every 15 minutes by agricultural and commercial customers. In another example, interval data may be measured every hour for residential customers. In some embodiments, the billing cycle data may comprise a single month. Therefore, in order to determine the billing cycle data, interval data collected during the desired month is collected and added together.

At step 203, the computer system acquires register data representing total utility resource consumption during the billing cycle. In some embodiments, the register data is transmitted from a distribution utility providing the utility resource to consumers. The register data may be determined at the end of each billing cycle. For example, the register may be determined at the end of every month.

At step 204, to ensure the accuracy and eliminate any defects in the interval data, the interval data is calibrated by comparing the sum of the intervals across a billing cycle against the register data for the same billing cycle. If the metered interval data is accurate, the sum of the interval cycles should be equivalent to register data. If the metered interval data is not accurate, in the calibration process, the interval data is scaled by a calibration factor. Calibration factor is calculated using the following equation:

$${I}^{′} ( n ) = I ( n ) * \{ \frac{{Σ}_{n} I ( n )}{R} \} \vert$$

wherein,
I(n) is the interval data for the billing cycle
R is the register data for the same billing cycle
ΣₙI(n) is the sum of all intervals within the same billing cycle.

At step 205, the computer system calibrates the plurality of interval data by applying the calibration factor to each interval data of the plurality of plurality of data. For example, the calculated calibration factor from step 204 may be multiplied to each interval data. Each of the resulting data may be calibrated interval data.

At step 206, the computer system acquires distribution loss factor (DLF) data. In some embodiments, the DLF may be acquired from a distribution utility.

At step 207, the computer system generates corrected interval data by applying a distribution loss factor to the calibrated interval data. For example, the corrected and calibrated interval data may be calculated by multiplying the calibrated interval data described above with a DLF. The corrected and calibrated interval data may be expressed using the equation:

Interval_{corrected}=Interval*DLF (Voltage Level, Hour_of_Day)

The DLF is a function of Voltage Level and Hour of the Day and published by each distribution utility.

At step 208, the computer system aggregates the corrected and calibrated interval data across all customers within a sub-population of customers who share the same pricing plan into the SQMD.

At step 209, the computer system repeats the above steps 201 through 208 using the updated data and revises the SQMD based on the Independent System Operator published settlement cycles. For example, the revisions may be submitted according to CAISO SQMD settlement cycles and other Submission Requirements. Additional information may be found in “Meter Data Acquisition and Processing Procedure,” available at https://www.caiso.com/Documents/5740.pdf and in “California Independent System Operator Corporation Fifth Replacement FERC Electric Tariff,” available at https://www.caiso.com/Documents/Section10_Metering_May1_2014.pdf.

In some embodiments, the SQMD for the second settlement cycle is revised based on the SQMD for the first settlement cycle. For example, the deadlines to submit SQMD may be determined using table 1 below:

TABLE 1

| Settlement Cycle | SQMD Submission Date | CAISO Settlement Date |
|---|---|---|
| 1 | T + 8B | T + 12B |
| | (Before 24:00) | |
| 2 | T + 48B | T + 55B |
| | (Before 24:00) | |

In table 1, for the first settlement cycle, the SQMD submission date is the trading day plus eight business days. The CAISO settlement date for the first settlement cycle is the trading day plus 12 business days. Similarly, the SQMD submission date for the second settlement cycle is the trading day plus 48 business days. The CAISO settlement date for the second settlement cycle is the trading day plus 55 business days. The deadlines to submit T+8B and T+48B may be determined by the CAISO's settlement schedules, which can be found here: http://www.caiso.com/market/Pages/Settlements/Default.aspx.

Procedures for Determining SQMD from MV90 Meters

FIG. 3a illustrates a process 301 for determining SQMD from MV90 meters. In step 310, interval and register data from a MV90 meter is acquired from distribution utility and validated. In step 311, the interval data is corrected by DLF in a manner consistent with steps 207 and 208 of FIG. 2 above.

In step 312 SQMD is then calculated based on the acquired and corrected interval data. Calculation of SQMD involves aggregating the interval data across all customers within the sub-population of customers sharing the same pricing plan.

In some embodiments, 15-minute MV90 meter interval data is first aggregated into hourly interval data. The hourly interval data is then corrected for DLF and then aggregated across all customers sharing the same pricing plan to calculate the SQMD for reporting to an Independent System Operator (ISO) such as the CAISO. In some embodiments, the customers may have solar generation. The interval data from MV90 representing the amount of utility resources consumed is first netted, on an hour by hour basis, against the interval data representing the generation (e.g., interval consumption minus interval generation) before aggregating corrected and netted intervals into SQMD.

In step 313, process 301 determines whether to acquire more metered data or proceed to revise the generated SQMD. If more metered data should be acquired, process 301 proceeds to 310. On the other hand, if the generated SQMD should be revised, process 301 proceeds to step 314.

In step 314, the calculated SQMD is revised across settlement cycles. In some embodiments, the SQMD may be revised in a manner consistent with step 209 of FIG. 2.

Procedure for Determining SQMD from Smart Meters

FIG. 3b illustrates a process 302 for determining SQMD from smart meters. In step 320, interval and register data from a smart meter are acquired from distribution utility. In some embodiments, the interval data is collected every 15 minutes from commercial and agricultural customers by the distribution utility. Similarly, in some embodiments, the interval data is collected every hour for residential customers by the distribution utility.

In step 321, the metered data collected by smart meters may be pre-processed prior to the calculation of SQMD. In some embodiments, the calibration may be performed in a manner consistent with steps 204 and 205 of FIG. 2.

In step 322, the calibrated interval data is corrected for distribution loss before being used to calculate SQMD by multiplying the calibrated interval described above with a distribution loss factor (DLF). Accounting for distribution loss be performed in a manner consistent with steps 206 and 207 described above.

In step 323, SQMD is calculated based on the calibrated and corrected interval data by aggregating across all customers within the same pricing plan. In some embodiments, the calculation of SQMD involves aggregating the calibrated and corrected hourly interval data and/or the treatment of interval data for NEM data. The calculation may be performed in a manner consistent with step 312 as described above.

In step 324, process 302 determines whether to acquire more metered data. If more metered data should be acquired, process 302 proceeds to 320. On the other hand, if no more metered data should be acquired, process 302 proceeds to step 325.

In some embodiments, steps 320-323 may be performed once every day. After processing steps 320-323 for several cycles, process 302 proceeds to step 325 to revise the generated SQMD.

In step 325, the calculated SQMD is revised with the more up to date data across settlement cycles. The revisions may be submitted according to the rules and regulations of Independent System Operators. The calculation may be performed in a manner consistent with step 314 described above, which involves revising SQMD for MV90 metered data.

Determining SQMD from Analog Meters

FIG. 3c illustrates a process 303 for determining SQMD from analog meters. In step 330, register data from an analog meter is acquired from distribution utilities. In some embodiments, the meter data may be read by a meter operator or transmitted to a meter operator via a data network.

In step 331, load profiles are derived using data sets based upon a variety of method. For example, load profiles may be derived based upon distribution utility published system-wide consumption patterns. In another example, load profiles may be derived from the calibrated interval data of the rest of customer population, including smart meters and MV90 meters, by aggregating the calibrated interval data across all the customers.

Additionally, it is not necessary to limit a load profile to a specific locality. For example, consumption data may be collected from across a geographically wide span of non-contiguous localities. The consumption data set may be compiled based upon the type of consumer rather than by their locality. For example, interval data for commercial facilities across non-contiguous regions may be collected. Similarly, consumption data for single family homes may be collected and compiled into a data set, while consumption data for large residential buildings may be collected and compiled into a separate data set.

In step 332, the register billing data collected by analog meters is retrofitted with the Load Profiles from step 331 to derive the interval data.

In step 333, the retrofitted interval data is corrected for distribution loss by multiplying the retrofitted interval data described above with a distribution loss factor (DLF). Accounting for distribution loss be performed in a manner consistent with steps 206 and 207 as described above.

In step 334, the SQMD is calculated by aggregating the retrofitted and corrected interval data from all customers within the same pricing plan.

In step 335, process 303 determines whether to acquire more metered data. If more metered data should be acquired, process 303 proceeds to 330 and repeats 330 through 334. On the other hand, if no more metered data should be acquired, process 303 proceeds to step 335.

In step 336, the calculated SQMD is revised with more up to dated data across settlement cycles. Both register and derived interval data may be subject to revisions. The revisions may be submitted according to the rules and regulations of relevant Independent System Operators. The calculation may be performed in a manner consistent with steps 314 and 325 described above, which involves revising SQMD for MV90 metered data.

The stored SQMD results may also be exported to SQMD files. The SQMD files may then be accessed for data comparison, analyses, and auditing purposes. Additionally, the exported SQMD files must also be archived before being submitted to CAISO. The SQMD results may be validated before being submitted to CAISO. Two validation methods are envisioned: automatically through pre-configured rules and scripts and manually using a user interface.

### Network System and Processing System

### Network System

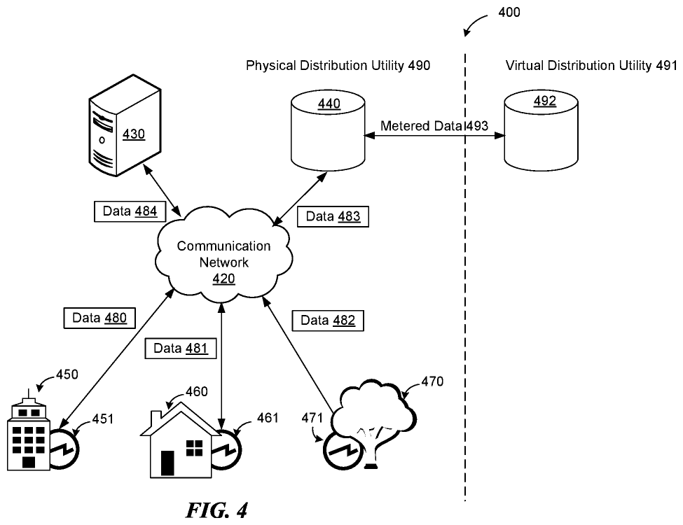

The SQMD results may be stored in a database for archiving and future reference. The database may be stored in local storage or remote storage. For example, the database may be hosted on a local computing device or remote computing device. Remote computing devices may be communicatively connected via a communication network. Additionally, the stored data may be transmitted to remote computing devices via wired or wireless systems. The storage of the SQMD results across local storage and remote storage may be implanted in accordance with communication system 400 depicted in FIG. 4.

Communication system 400 facilitates the functionality of the system for calculating SQMD. Communication network 400 allows for data communication between computing device 430 and utility meters 451, 461, and 471. One functionality of utility meters 451, 461, and 471 is to measure metered data 480-482 that indicate the usage or consumption of utility resources. Utility meters may be deployed in different locations for different applications. For example, utility meter 451 may be deployed at an industrial or commercial site 450 for measuring utility resource usage at that site. Similarly, utility meter 461 may be deployed at a residential home 460 for measuring utility resource usage at the residence. Finally, utility meter 471 may be deployed at an agricultural site 470 for measuring utility resource usage at the agricultural site. Additionally, each of utility meters 451, 461, and 471 may be a different type of meter such as smart meters, MV90 meters and analog meters.

Communication network 420 allows for metered data 480-482 to be transmitted to computing device 430 and/or remote data storage 440. Additionally, communication network 420 allows the exchange of calculated SQMD between computing device 430 and remote data storage 440. The connections established in communication network 420 between utility meters 451, 461, and 471, computing device 430, and remote data storage 440 may be facilitated using wired or wireless technologies. Additionally, communication network 420 may include additional utility meters, computing devices, remote data storage units, and other devices. In some embodiments, metered interval data 493 may be exchanged between physical distribution utility 490 and virtual distribution utility 491 using remote data storage 440 and remote data storage 492, respectively.

### Processing System

FIG. 5 is a block diagram illustrating an example of a processing system 400 in which at least some operations described herein can be implemented.

The processing system 500 may include one or more central processing units (“processors”) 502, main memory 506, non-volatile memory 510, network adapter 512 (e.g., network interface), video display 518, input/output devices 520, control device 522 (e.g., keyboard and pointing devices), drive unit 524 including a storage medium 526, and signal generation device 530 that are communicatively connected to a bus 516. The bus 516 is illustrated as an abstraction that represents one or more physical buses and/or point-to-point connections that are connected by appropriate bridges, adapters, or controllers. The bus 516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 500 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 500.

While the main memory 506, non-volatile memory 510, and storage medium 526 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 528. The term “machine-readable medium” and “storage medium” shall also be taken to include any medium that can store, encoding, or carrying a set of instructions for execution by the processing system 500.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in a computing device. When read and executed by the one or more processors 502, the instruction(s) cause the processing system 500 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 510, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 512 enables the processing system 500 to mediate data in a network 514 with an entity that is external to the processing system 500 through any communication protocol supported by the processing system 500 and the external entity. The network adapter 512 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 512 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications, and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLD's), field-programmable gate arrays (FPGAs), etc.

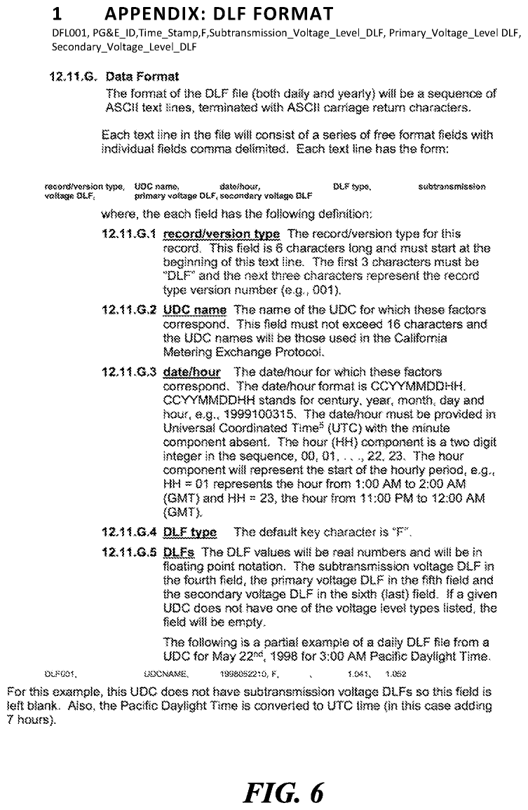

FIG. 6 depicts a diagram of the distribution loss factor file format. The format utilizes ASCII text lines and terminates with an ASCII carriage return. Additionally, each line in the file consists of a series of free format fields with individual fields that are comma delimited.

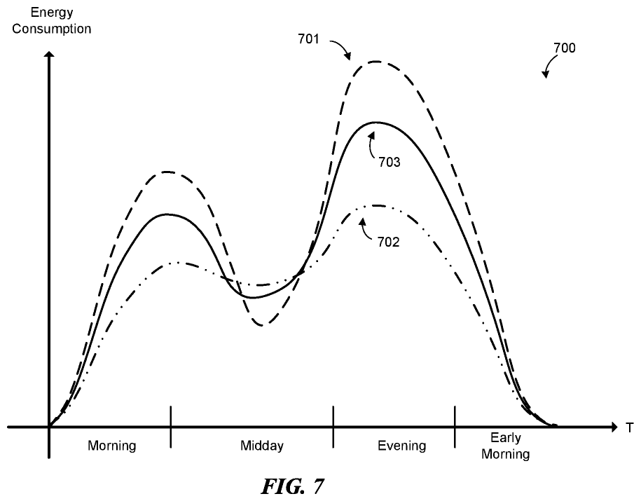

FIG. 7 is a chart depicting the energy consumption of various groups of utility resource consumers. Specifically, curves 701 and 702 each represent the energy consumption of a group of utility consumers throughout a single day. Curve 703 represents the average energy consumption of curves 701 and 702. In some embodiments, each group of utility resource consumers may be defined by geography, billing rate, type of consumer, or any other characteristic. For example, the group of utility resource consumers may be defined by a virtual whole metering group.

In one example, curve 701 represents a virtual wholesale metering group comprising a group of consumers that consume a large amount of energy but also generates a large amount of energy. The virtual wholesale metering group may generate energy during the midday period from NEM consumers. The NEM consumers may generate energy, for example, using solar panels that generates the most energy during midday when the sun is strongest. Therefore, during the midday period, the net consumption of energy of the virtual whole metering group depicted in curve 701 drops significantly.

In contrast, curve 702 represents a virtual wholesale metering group comprising a group of consumers that consume a smaller amount of energy but also generates a small amount of energy. The wholesale metering group may represent consumers that generally consumes less energy due to weaker demand, smaller population, etc. Additionally, the wholesale metering group may generate less energy, for example, because less sunlight is available to generate electricity using solar panels. As a result, the peak demand of curve 701 is lower than the peak demand of curve 701. Additionally, the lowest demand of curve 701 is higher than the lowest demand point of curve 702. Finally, curve 703 represents the average value of curves 701 and 702.

Curves 701-703 may be generated using load profile data from utility distributors. Alternatively, curves 701-703 may be generated from SQMD data such as data generated using the processes in FIG. 2 or FIGS. 3a-3c. Additionally, curves 701-703 may be used to determine the peak demand of a particular group of consumers. Additionally, it may be used to provision utility resource capacity that exceeds the load profile or measured peak demand. By using the SQMD to provision enough capacity, resources may be saved because demand is more accurately determined.

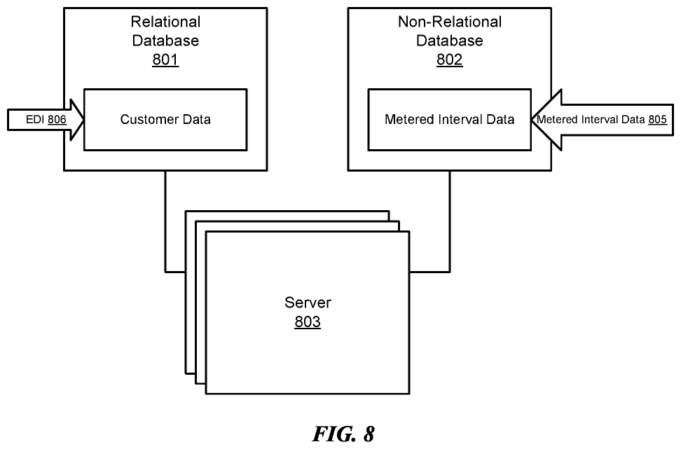

FIG. 8 depicts a system 800 for providing virtual wholesale metering in a population of utility resource consumers using SQMD from retail utility meters. In some embodiments, the system may include a relational database 801, non-relational database 802, and server 803. In some embodiments, the relational database 801 and/or non-relational database 802 are remotely located from server 803 and connected via a data network. In other embodiments, the relational database 801 and/or non-relational database 802 may be implemented as part of server 803.

Relational database 801 may be configured to store customer data associated the population of utility resource consumers including the meter type. The customer data may be attribute data representing a group of utility resource consumers, wherein the consumers in the group may have a shared customer characteristic such as a geographical location, billing plan, and/or utility rate class.

In some embodiments, relational database 801 may receive customer data from an electronic data interchange (EDI) 806. EDI is a standardize electronic format for exchanging data between partners. Using EDI, businesses may communicate documents or information without using physical paper. The standardized format allows documents to be transmitted, received, and parsed automatically. Additionally, using EDI, direct access transaction sets may be defined to allow the exchange of messages related to utility information including billing, payment, remittance, meter usage, etc. In particular, a message may be defined to transfer metered data.

Non-relational database 802 may be configured to store metered interval data 805 of each retail utility meter associated with the population of utility resource consumers, each retail utility meter measuring the utility resource at the retail utility meter. The stored metered interval data 805 may be interval data measured by each utility retail meter, either on an hourly or every 15-minute basis, and collected by distribution utilities. Additionally, the metered interval data 805 may need to be corrected for DLF or revised with updated or more recent interval data. Non-relational database is used for three primarily considerations. First, the interval data may be very large in volume since it is collected at a high frequency from a large number of retail meters. Second, the procedures used to calculate the SQMD above involves a set of complex data processing. To support the data processing, Non-relational database is used for its speed and computation power. Lastly, the procedures to calculate the SQMD involves repeated retrieval and storage of a large number of interval data. Non-relational database is more efficient for storing data in a columnar format for a repeated retrieval and storage of the interval data.

System 800 may also include a server 803. In some embodiments, server 803 may be a cluster of servers. Server 803 may be configured to determine a group of retail utility meters for virtual wholesale metering. Server 803 may collect customer data associated with the group of retail utility meters and use it to guide the calibration, correction and, for the analog meters, retrofitting of interval data before calculation of SQMD. In some examples, the customer data may be collected from the relational database 801, while the interval meter data of the group of retail utility meters from the non-relational database.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A method for providing virtual wholesale metering in a population of utility resource consumers using interval data collected from retail utility meters that has been calibrated by a utility server, the method comprising:
acquiring, by the utility server, a plurality of interval data indicating utility resource consumption measured by a utility meter,
determining, by the utility server, billing cycle data by summing the acquired plurality of interval data;
acquiring, by the utility server, register data representing utility resource consumption during the billing cycle, the register data transmitted from a distribution utility operating the utility meter;
comparing, by the utility server, the register data to the billing cycle data to determine a calibration factor, wherein the product of the calibration factor and the billing cycle data is equal to the register data;
calibrating, by the utility server, the plurality of interval data by applying the calibration factor to each interval data of the plurality of plurality of data;
generating, by the utility server, calibrated billing cycle data by summing the plurality of calibrated interval data; and
generating, by the utility server, corrected billing cycle data by applying a distribution loss factor to the calibrated billing cycle.

2. The method of claim 1, further comprising: acquiring distribution loss factor data from a utility distributor.

3. The method of claim 1, further comprising: revising the corrected billing cycle by re-performing the steps of claim 1 after a predetermined period of time.

4. The method of claim 1, wherein the utility meter is a smart meter that reads interval data every preset interval and register data per billing cycle.

5. The method of claim 1, wherein the utility meter is a MV90 meter that reads interval data.

6. The method of claim 1, wherein the utility meter is an analog meter that reads register data.

7. The method of claim 1, wherein the plurality of interval data indicates utility resources generated by a net energy metering (NEM) consumer.

8. A method for generating settlement quality metering data (SQMD), the method comprising:
determining, by the utility server, billing cycle data by summing a plurality of interval data during a billing cycle;
determining, by the utility server, a calibration factor, wherein the product of the calibration factor and the billing cycle data is equal to a register data; and
generating, by the utility server, calibrated billing cycle data by applying the calibration factor to each interval data of the plurality of plurality of data and summing the plurality of calibrated interval data.

9. The method of claim 8, further comprising: generating, by the utility server, corrected billing cycle data by applying a distribution loss factor to the calibrated billing cycle.

10. The method of claim 8, wherein the plurality of interval data is acquired from a utility meter.

11. The method of claim 8, wherein the register data indicates the amount of utility resource consumed at a the utility meter during the billing cycle, wherein the register data is acquired from a utility resource distributor.

12. The method of claim 8, wherein the utility meter measures utility resource consumption of a location associated with the utility meter at regular intervals.

13. The method of claim 8, wherein the register data is transmitted from a utility distributor providing the utility resource to the location associated with the utility meter.

14. A system for providing virtual wholesale metering in a population of utility resource consumers using meter data collected from retail utility meters, the system comprising:
a relational database configured to store customer data associated the population of utility resource consumers;
a non-relational database configured to store metering data of each retail utility meter associated with the population of utility resource consumers, each retail utility meter measuring the utility resource at the retail utility meter; and
a server configured to:
determine a group of retail utility meters for virtual wholesale metering;
collecting, from the relational database, customer data associated with the group of retail utility meters;
collecting, from the non-relational database, metering data of the group of retail utility meters;
refining the collected metering data; and
calculating metering data for the group of retail utility meters.

15. The system of claim 14, further comprising: determining, by the utility server, a resource adequacy requirement based on the calculated metering data for the group of retail utility meters.

16. The system of claim 14, wherein the metering data is interval data measured by each utility retail meter and collected by utility distributors.

17. The system of claim 14, wherein refining the collected metering data further comprises accounting for DLF.

18. The system of claim 14, wherein refining the collected metering data further comprises revising the metering data.

19. The system of claim 14, wherein the group of retail utility meters is determined based upon a shared customer characteristic such as a geographical location, billing plan, and/or utility rate class.

20. The system of claim 14, wherein the relational database and/or non-relational database are remotely located from the server.

21. The system of claim 14, wherein the metering data stored in the non-relational database is retrieved via an electronic data interchange (EDI).

22. The system of claim 14, wherein the group of retail utility meters comprises a customer population located in a geographically either contiguous and non-contiguous area.

23. The system of claim 14, wherein the group of retail utility meters is determined by demographic and other features, such as gender, income, and/or age.

24. A method to derive the approximate interval data for a sub-population of customers from a combination of monthly total reads and the load profile generated from the interval data for the rest of the population, the method comprising:
determining, by a utility server, billing cycle data by summing a plurality of interval data during a billing cycle;
determining, by the utility server, a calibration factor, wherein the product of the calibration factor and the billing cycle data is equal to a register data; and
generating, by the utility server, calibrated billing cycle data by applying the calibration factor to each interval data of the plurality of plurality of data and summing the plurality of calibrated interval data.

25. A method to improve the accuracy of interval data by calibrating the interval data against the monthly aggregated total reads, the method comprising:
comparing, by a utility server, a register data to the monthly aggregated total reads to determine a calibration factor, wherein the product of the calibration factor and the monthly aggregated total reads is equal to the register data;
calibrating, by the utility server, a plurality of interval data by applying the calibration factor to each interval data of the plurality of plurality of data; and
generating, by the utility server, calibrated billing cycle data by summing the plurality of calibrated interval data.
